(19) United States
(12) Patent Application Publication
(10) Pub. No.: US 2013/0292596 A1
(43) Pub. Date: Nov. 7, 2013

(54) Offset type camming plug valve

(71) Applicant: Hans D.B. Baumann, W. Palm Beach, FL (US)

(72) Inventor: Hans D.B. Baumann, W. Palm Beach, FL (US)

(21) Appl. No.: 13/506,646

(22) Filed: May 7, 2012

(51) Int. Cl. F16K 1/38

(52) U.S. Cl. 251/333

(57) ABSTRACT

An offset type camming plug valve comprising a housing having inlet and outlet ports connected by a reduced orifice, a plug capable of swinging to and from said orifice and motivated by a rotating shaft whose center is offset from the axis of said orifice and wherein said plug has a slotted opening communicating with the orifice when the plug has been rotated from the close position.

### INTRODUCTION AND BACKGROUND OF THE INVENTION

My invention relates to the field of automatic control and more specificly to Control Valves used in the regulation of flow, pressure, or temperature, for example, as is common in the process industry.

A more refined application can be found in the climate control of buildings handling chilled water or steam, for example. Such valves tend to be small, need to be less costly, and be reliable.

Globe style control valves have been used in the past. However, they tend to be more bulky, are more costly, and offer only restricted flow capacity. Ball valves are another typical alternative comprising a pieced ball, squeezed between a pair of Teflon seals and rotated by a shaft. While such valves have more than ample flow capacity, they tend to be hard to operate due to the great friction exerted by the seals, when one attempts to open such valves. This necessitates the use of strong, and hence more costly, operating devices. This friction also creates undesirable dead-band or hysteresis, a major detriment for automatic and stable control.

The current invention overcomes all such objections in that it has ample flow capacity, in excess of what is offered in globe valves; it is of compact size and consists of few parts, all major cost savings. Finally, with exception of a low stem seal friction, there is virtually no operating friction, offering the use of much smaller (and hence less costly) operating devices. Such absence of objectionable operating friction also allows for a very smooth and stable control action, translatable into a much closer temperature control.

### BRIEF DESCRIPTION OF THE DRAWINGS

FIG. 1 depicts a preferred embodiment of the invention in a central, cross-sectional view.

FIG. 2 shows a vertical, cross-sectional view along the lines 5-5 in FIG. 1 with the plug in an open position.

FIG. 3 is a graphical depiction of the relationship between flow passing the valve and the travel of the plug either with, or without the bulbous extension of the plug.

### DESCRIPTION OF THE INVENTION

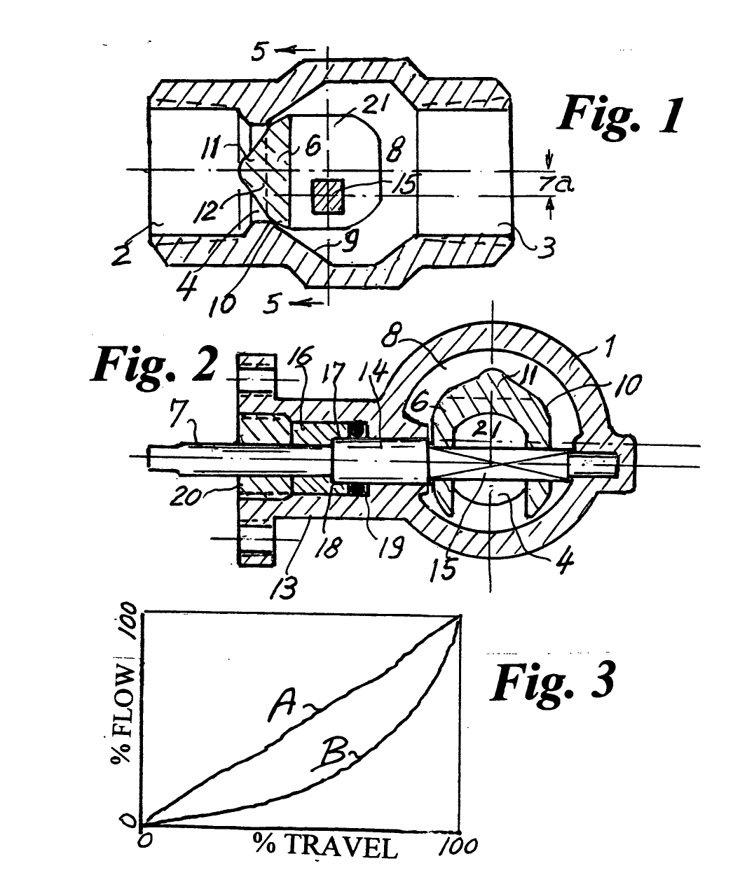

Referring to FIG. 1, which shows a housing 1 having an inlet port 2 and an outlet port 3. An orifice 4 is disposed between said ports and is capable of engaging a plug 6 rotatably motivated by a shaft 7 whose central axis is offset 7a from the axis connecting ports 2 and 3. Such an offset ranges typically between 15 and 40 percent of the diameter of orifice 4. Housing 1, furthermore has an enlarged center section 8 terminating via a tapered ending 9 at said orifice 4.

Plug 6 has a spherical circumferential portion 10 capable of closingly engaging the intersection between the orifice 4 and said tapered ending 9, wherein the tapered ending of center section 8 assists plug 6 to center itself when approaching said orifice.

Plug 6 furthermore has a bulbous extension 11, configured to sweep by the corner of the orifice, defined as the upper part of inner circumference facing the tapered ending 9, when the plug is rotated up to 45 degrees away from the closed position. This will limit the flow passing that portion of the orifice, resulting in a more gradual opening characteristic between flow and plug travel as depicted by curve B in FIG. 3.

The bulbous extension 11 can be omitted (see dotted line 12) whenever an alternate linear relationship, as shown in line A of FIG. 3, is desired. This will result in a more rapid increase in flow area between orifice 4 and plug 6.

Housing 1 has a neck 13 as shown in FIG. 2, containing shaft 7 having an enlarged diameter portion 14 and a square shaped section 15, passing through a similarly shaped opening in plug 6. This section allows plug 6 to be rotated by shaft 7, yet allows plug 6 to slide freely along the central axis of shaft 7 in order to more perfectly align with orifice 4.

Neck 13 in addition, houses a guide bushing 16 having a recess 17 containing therein a shouldered portion 18 of shaft 7, to prevent the latter to be expelled by fluid forces from housing 1.

Finally, a seal 19 is retained between a recess in neck 13 and guide bushing 16, while a threaded retainer 20 keeps the guide bushing 16 in its proper location.

Plug 6 features a slotted opening 21, more clearly shown in FIG. 2. This opening allows a direct passage from orifice 4 to outlet port 3, or from port 3 to port 2 if so desired, when the plug is close to being fully rotated away from said orifice. This arrangement greatly increases the flow capacity of my invention.

Having thus shown the function and features of the invention in a preferred embodiment, it should be understood that numerous changes can be made without departing from the scope of the following claims. For example: A pin might connect the plug to a round shaft instead of using a square and, a flange or a retaining ring might be employed instead the shown threaded retainer to keep the guide bushing in place. Furthermore, flange connections to a pipeline could replace the threaded ports shown in FIG. 1.

Finally, a separate seat ring, perhaps made from a harden able metal, might be inserted at a proper location within said housing, instead of the lower cost, integral orifice being part of said housing.

1. An offset type camming plug valve comprising, a housing having an inlet and an outlet port, an orifice disposed between said inlet and outlet ports, a plug located between said orifice and said outlet port and motivated to swing in an arc from and to said orifice in order to regulate the flow of fluid between said ports, and wherein said plug has a spherical center portion capable of sealingly interfacing with said orifice.

2. An offset type camming plug valve as in claim 1, wherein the diameter of said orifice is between 40 and 80 percent of the diameter of said inlet port.

3. An offset type camming plug valve as in claim 1, wherein said housing has a third opening extending at a centerline located perpendicular to an axis connecting said ports and said orifice, and wherein said axis of the third opening furthermore is vertically offset from the axis passing through said orifice.

4. An offset type camming plug valve as in claim 3, wherein the vertical distance between the center of said third opening and the axis passing through said orifice is between 15 and 40 percent of the diameter of said orifice.

5. An offset type camming plug valve as in claim 4, wherein said plug has a pierced opening located eccentrically to the center of said ball and receiving therein a shaft passing additionally through said third opening within said housing.

6. An offset type camming plug valve as in claim 5, wherein the third opening furthermore retains a sealing device capable of preventing fluid from escaping from the interior of said housing and along the outer surface of said shaft.

7. An offset type camming plug valve as in claim 6, wherein said sealing device is suitably retained within said housing and furthermore has a shoulder contacting a similar shoulder as part of said shaft, capable of preventing fluid pressure from expelling said shaft from the housing's interior.

8. An offset type camming plug valve as in claim 7, wherein said housing furthermore has an enlarged bore located between said orifice and said outlet port.

9. An offset type camming plug valve as in claim 8, wherein said plug has a bulbous extension centering said spherical center portion and dimensioned to slide past the corner of the orifice interconnecting with the enlarged bore, to partly block fluid flow past a portion of the circumference of said orifice through up to fifty percent of the plug's rotary motion.

10. An offset type camming plug valve as in claim 1, wherein said plug has a slotted opening located opposite said spherical center portion and capable of providing a passage for fluid exiting said orifice when the plug is in or near ninety degrees from the closed position.

11. An offset type camming plug valve as in claim 5, wherein a portion of said shaft has a square profile interfacing with a similarly dimensioned opening in the plug in order to permit rotation of the latter, yet enabling the plug to slide along the axis of the shaft in order to better align with said orifice.

12. An offset type camming plug valve as in claim 8, wherein said enlarged bore reduces conically towards the orifice, in order to provide a cradle for the swinging ball as it approaches said orifice.
